(19) United States
(12) Patent Application Publication
(10) Pub. No.: US 2014/0262747 A1
(43) Pub. Date: Sep. 18, 2014

(54) Process and Apparatus for Functionalizing and/or Separating Graphene Particles and Other Nanomaterials

(71) Applicant: Graphene Technologies, Inc., Novato, CA (US)

(72) Inventors: Robert Wayne Dickinson, San Rafael, CA (US); Donald Brookshire, JR., Mill Valley, CA (US); Lawrence Joseph Musetti, San Rafael, CA (US); Theodore Joseph Musetti, Novato, CA (US)

(73) Assignee: Graphene Technologies, Inc., Novato, CA (US)

(21) Appl. No.: 14/216,253

(22) Filed: Mar. 17, 2014

Related U.S. Application Data
(60) Provisional application No. 61/788,999, filed on Mar. 15, 2013.

(51) Int. Cl. B01J 19/08; B03C 7/02

(52) U.S. Cl. CPC B01J 19/088; B03C 7/02; B82Y 40/00
USPC 204/164; 422/186.05; 204/450; 204/600; 977/840

(57) ABSTRACT

Process and apparatus for functionalizing and/or separating graphene particles and other nanomaterials in which graphene and other nanoparticles are placed in a pile on one of two opposing conductive surfaces that are charged with a high D.C. voltage so that material of a certain character is attracted to the other conducting surface. This process takes place in an enclosed chamber that has been flooded with a designated gas at ambient pressure, with the material attracted to the second conducting surface passing through the designated gas. The high energy field creates a condition such that the material remaining on the first conductive surface takes on atoms of the designated gas and material the going to the second surface is further exposed to and characterized by the designated gas.

### RELATED APPLICATIONS

Provisional Application No. 61/788,999, filed Mar. 15, 2013, the priority of which is claimed.

### BACKGROUND OF THE INVENTION

1. Field of Invention

This invention pertains generally to the manufacture of nanomaterials and, more particularly, to a process and apparatus for functionalizing and/or separating graphene particles and other nanomaterials.

2. Related Art

Functionalization by surface modification is an important step in imparting characteristics to graphene and other nanomaterials that enable, improve, and/or optimize the material for specific applications.

Techniques heretofore employed in the functionalization of graphene and other carbon and non-carbon nanomaterials are typically carried out in a vacuum. The use of vacuum pumps and pressures inn processing nanoparticles having small facial dimensions, typically less than 100 nm, creates problems because of the difficulty of containing the particles.

Another problem is that particles of this small size cannot be processed in the presence of air turbulence, which is present even in partial vacuums, because sub-100 nm scale particles will disperse like smoke in a gaseous environment and are very difficult to collect.

### OBJECTS AND SUMMARY OF THE INVENTION

It is, in general, an object of the invention to provide a new and improved process and apparatus for functionalizing graphene and other nanoparticles and/or separating such particles according to size.

Another object of the invention is to provide a process and apparatus of the above character which do not require the use of a vacuum.

These and other objects are achieved in accordance with the invention by providing a process and apparatus in which graphene and other nanoparticles are placed in a pile on one of two opposing conductive surfaces that are charged with a high D.C. voltage so that material of a certain character is attracted to the other conducting surface. This process takes place in an enclosed chamber that has been flooded with a designated gas at ambient pressure, with the material attracted to the second conducting surface passing through the designated gas. The high energy field creates a condition such that the material remaining on the first conductive surface takes on atoms of the designated gas and the material going to the second surface is further exposed to and characterized by the designated gas.

### BRIEF DESCRIPTION OF THE DRAWINGS

FIG. 1 is a block diagram of one embodiment of a system for functionalizing and separating graphene and other nanoparticles in accordance with the invention.

FIG. 2 is an isometric view of the electrode plates in the embodiment of FIG. 1.

FIG. 3 is a block diagram of another embodiment of a system for functionalizing and separating graphene and other nanoparticles in accordance with the invention.

FIG. 4 is an isometric view of the electrode plates and screen in the embodiment of FIG. 3.

FIG. 5 is an isometric view of a pair of inwardly convex electrode plates for use in the embodiment of FIG. 1.

FIG. 6 is an isometric view of a pair of inwardly concave electrode plates with a screen between them for use in the embodiment of FIG. 2.

FIG. 7 is an isometric view of a pair of inwardly concave electrode plates for use in the embodiment of FIG. 1.

FIG. 8 is an isometric view of a pair of inwardly convex electrode plates with a screen between them for use in the embodiment of FIG. 2.

FIG. 9 is an isometric view of a pair of rotating electrode plates for use in the embodiment of FIG. 1.

FIG. 10 is an elevational view of the rotating electrode plates of FIG. 9.

FIG. 11 is an isometric view of a pair of rotating electrode plates with a screen between them for use in the embodiment of FIG. 2.

FIG. 12 is an elevational view of the rotating electrode plates and screen of FIG. 11.

FIG. 13 is an isometric view of another pair of electrode plates for use in the embodiment of FIG. 1.

FIG. 14 is an isometric view of another pair of electrode plates with a screen between them for use in the embodiment of FIG. 2.

FIG. 15 is an isomeric view of another set of electrodes for use in the embodiment of FIG. 1.

FIG. 16 is an isomeric view of another set of electrodes for use in the embodiment of FIG. 2.

FIG. 17 is an isomeric view of another set of electrodes for use in the embodiment of FIG. 1.

FIG. 18 is an isomeric view of another set of electrodes for use in the embodiment of FIG. 2.

FIG. 19 is an isomeric view of another set of electrodes for use in the embodiment of FIG. 1.

FIG. 20 is an isomeric view of another set of electrodes for use in the embodiment of FIG. 2.

### DETAILED DESCRIPTION

As illustrated in FIGS. 1 and 2, the apparatus includes a pair of electrically conductive plates or electrodes 31, 32 spaced vertically apart within a housing 33. A D.C. charging voltage is applied to the plates from a high voltage power supply 34. In this particular embodiment, the positive terminal of the power supply is connected to the upper plate, and the negative terminal is connected to the lower plate via the system ground. However, the polarity is not critical and can be reversed, if desired, with the positive terminal being connected to the lower plate and the negative terminal connected to the upper plate. A capacitor 36 is connected between the plates.

In one exemplary embodiment, the electrodes are 12 inch square flat copper plates which are ¼ inch thick and spaced 2 inches apart. In this example, the power supply is a variable supply that can apply up to 20 KV to the plates, and capacitor 36 has a capacitance of 0.1 μF and a voltage rating of 20 KV.

The particles to be functionalized and/or separated are placed in a pile 37 on the upper surface of lower electrode plate 12. The housing is closed, and the chamber within the housing is flooded with a suitable gas at ambient pressure. When the D.C. voltage is applied to the plates, some of the graphene particles are attracted and adhere to the lower surface of upper plate 11, as indicated at 38. The particles in the pile and the particles attracted to the upper plate take on atoms of elements in the gas, thereby imparting functional characteristics to the material.

A particularly preferred process for producing graphene particles for functional ization and/or separation by the invention is described in detail in U.S. Pat. No. 8,420,042, the disclosure of which is incorporated herein by reference. In that process, magnesium and carbon dioxide are combusted together in a highly exothermic reaction to produce carbon and magnesium oxide (MgO) products which are then separated and purified to produce graphenes of very high purity and quality. The purified graphene particles are ground and screened to provide particles of a desired size ranging from about 120 mesh to about 400 mesh.

The gas introduced into the chamber is selected in accordance with the characteristics to be imparted to the particles. If the particles are to be functionalized, a functionalizing gas is used, and if the particles are being separated without functionalization, a gas such as carbon dioxide (CO2) or nitrogen (N2) is utilized to prevent combustion of the graphene particles. Suitable gases for functionalizing the graphene include oxygen, nitrogen, water vapor, hydrogen peroxide, carbon dioxide, ammonia, ozone, carbon monoxide, silane, dimethysilane, trimethylsilane, tetraetoxysilane, hexamethyldisioxane, chloro-silanes, fluoro-silanes, ethylene diamine, maleic anhydride, arylamine, acetylene, methane, ethane , propane, butane, ethylene oxide, hydrogen, air, sulfur dioxide, hydrogen, sulfonyl precursors, argon, helium, alcohols, methanol, ethanol, propanol, carbon tetrafluoride, carbon tetrachloride, carbon tetrabromide, chlorine, fluorine, and bromine.

With or without functionalizing gasses, the invention acts as a particle sorting tool by preferentially transferring smaller particles of graphene and other nanomaterials to the upper electrode plate and thereby separated from the general mass of graphene powder on the lower plate. These transferred particles have been found to be surprisingly small, with cross sectional dimensions less than one tenth those of the particles in the general mass. The high energy to which the particles are exposed may impart or alter the characteristics of the transferred particles. Thus, for example, when 320 mesh graphene particles with a cross sectional dimension on the order of 10 microns are processed in the high voltage system, the particles collected from the upper plate have a cross sectional dimension on the order of 1 micron.

Also somewhat surprisingly, it has been observed that when additional material is piled on top of material that has already been processed, the yield increases from about 4 percent to about 50 percent.

Raman spectroscopic analysis has shown that samples prepared from similar graphene materials that were functionalized in a nitrous oxide (N2O) atmosphere by the high voltage process of the invention and in an N2O atmosphere in a conventional vacuum plasma reactor have similar Raman spectra, indicating that both samples were the same type of sp2 bonded carbon. Thus, the invention has made it possible to functionalize graphene materials without expensive plasma equipment that operates in a vacuum. The Raman analysis also suggests that it may be possible to control the degree of functionalization by controlling the time the material is in the functionalizing gas.

The embodiment illustrated in FIGS. 3 and 4 is similar to the embodiment of FIGS. 1 and 2, with the addition of a conductive metal screen 39 between the electrode plates. In this embodiment, the positive side of the high voltage supply is connected to the two plates, and the negative side is connected to the screen. The capacitor is connected between the two plates and the screen.

Operation and use of the embodiment of FIGS. 3 and 4 is similar to that of FIGS. 1 and 2. The particles or powder to be functionalized and/or separated are placed in a pile on the upper surface of the lower plate, the housing is closed, the chamber is flooded with gas at ambient pressure. When the D.C. voltage is applied to the plates and the screen, the smaller particles are attracted to the lower surface of the upper plate, taking on the atoms in the gas that impart functional characteristics to the material.

Instead of being flat or planar, the electrode plates can have other contours such as the inwardly convex plates 41, 42 shown in FIGS. 5 and 6 and the inwardly concave plates 43, 44 shown in FIGS. 7 and 8. Power is applied to these plates in the same manner it is applied to plates 31, 32 in the embodiment of FIG. 1. The curvature of the plates allows focusing, affects the rate of collection, and reduces arcing to allow operation at higher current levels. Flat, electrically conductive metal screens 46, 47 are disposed midway between the plates in the embodiments of FIGS. 6 and 8, and power is applied to the plates and screens in the same manner that it is applied to the plates and screen in the embodiment of FIG. 3.

FIGS. 9-12 illustrate embodiments in which the electrode plates are electrically conductive circular plates or disks 48, 49 which are spaced apart vertically and offset laterally for rotation about vertically extending axes 51, 52, with portions of the disks overlapping between the axes. The embodiment of FIGS. 11-12 also has a flat, electrically conductive screen 53 between the disks in the area where the disks overlap.

The plates and screen in these embodiments are energized in the same manner as the plates and screens in the previous embodiments, with the power being applied to the two plates in the embodiment of FIGS. 9-10 and between the plates and the screen in the embodiment of FIGS. 11-12.

Operation and use of the embodiments of FIGS. 9-12 is similar to that of the previous embodiments. The particles or powder to be functionalized and/or separated are placed in a pile on the upper surface of the lower disk, the housing is closed, and the chamber is flooded with gas at ambient pressure. When the D.C. voltage is applied to the disks or to the disks and screen, the smaller particles are attracted to the lower surface of the upper disk, taking on the atoms in the gas that impart functional characteristics to the material.

Collecting the functionalized and/or separated particles on a rotating disk provides faster rates of collection than collecting them on a stationary plate, and having both disks rotate facilitates the loading of material onto the lower disk prior to exposure to the electrically charged environment and allows the process to operate in a continuous mode. If desired, one of the disks can remain stationary, although that may make it more difficult to carry out the process on a continuous basis.

The embodiments shown in FIGS. 13 and 14 are similar to the embodiments of FIGS. 1-4 in that they have square, flat copper plate electrodes 56, 57 which are spaced apart vertically, with a flat, electrically conductive screen 59 between the plates in the embodiment of FIG. 14. Upper plate 56 is smaller in lateral dimension than lower plate 57 and is positioned above the central area of the lower plate. Power is applied to these plates and to screen 59 in the same manner that it is applied to the plates and screen in the embodiments of FIGS. 1-4, and the particles to be functionalized and/or separated are placed in the central area of the lower plate and processed in the same manner as in those embodiments.

In the embodiments of FIGS. 15 and 16, the electrodes consist of an electrically conductive, cylindrical drum 61 mounted for rotation about a horizontally extending axis 62 above a flat, electrically conductive plate 63, with a flat, electrically conductive screen 64 between the drum and the plate in the embodiment of FIG. 16. In the embodiment of FIG. 15, the high D.C. charging voltage is applied between the drum and plate with either polarity, and in the embodiment of FIG. 16, the positive side of the D.C. voltage is applied to the drum and plate, and the negative side is applied to the screen.

Particles to be functionalized and/or separated are placed in a pile on the plate beneath the drum, and the functionalized and/or separated particles are collected on the surface of the rotating drum at a faster rate than would be on a stationary plate.

FIGS. 17-20 illustrate embodiments having an upper electrode plate 66 mounted on rollers 67 for movement back and forth above a stationary lower plate 68. The rollers have grooved surfaces 67a, and the upper plate has guides 66a along its outer edges which are received in the grooves. A scraper 69 and a collection trough 71 are mounted in a stationary position near one end of the lower plate for removing and collecting particles from the lower surface of the upper plate. In the embodiment of FIGS. 17-18, the positive charge is applied to the upper plate, and the negative charge is applied to the lower plate. In the embodiment of FIGS. 19-20, a flat, electrically conductive screen 73 is disposed midway between the plates, the positive charge is applied to the two plates, and the negative charge is applied to the screen.

Particles to be functionalized and/or separated are placed in a pile on the upper surface of the lower plate, and the functionalized and/or separated particles attach to the lower surface of the upper plate. As the upper plate passes over the trough, the scraper engages the lower surface of that plate and scrapes the particles on it into the trough where they are collected. Here again, the moving plate is able to collect the processed particles at a faster rate than a stationary plate.

The invention has a number of important features and advantages. It provides a process and apparatus for functionalizing and/or separating graphene particles and other nanoparticles in an ambient plasma environment without the use of vacuum or other expensive plasma equipment.

It is apparent from the foregoing that a new and improved process and apparatus for functionalizing and/or separating graphene particles and other nanoparticles have been provided. While only certain presently preferred embodiments have been described in detail, as will be apparent to those familiar with the art, certain changes and modifications can be made without departing from the scope of the invention, as defined by the following claims.

1. A process for functionalizing and/or separating nanoparticles, comprising the steps of: placing the nanoparticles on one of two electrically conductive surfaces that face each other in a closed chamber, flooding the chamber with gas at ambient pressure, and applying a high voltage electrical charge to the electrically conductive surfaces to attract a portion of the nanoparticles from the first electrically conductive surface to the second electrically conductive surface.

2. The process of claim 1 wherein the gas is a functionalizing gas, and the nanoparticles attracted to the second electrically conductive surface take on characteristics of the functionalizing gas.

3. The process of claim 2 wherein nanoparticles remaining on the first electrically conductive surface also take on atoms of the functionalizing gas.

4. The process of claim 2 wherein the functionalizing gas is selected from the group consisting of oxygen, nitrogen, water vapor, hydrogen peroxide, carbon dioxide, ammonia, ozone, carbon monoxide, silane, dimethysilane, trimethylsilane, tetraetoxysilane, hexamethyldisioxane, chloro-silanes, fluoro-silanes, ethylene diamine, maleic anhydride, arylamine, acetylene, methane, ethane , propane, butane, ethylene oxide, hydrogen, air, sulfur dioxide, hydrogen, sulfonyl precursors, argon, helium, alcohols, methanol, ethanol, propanol, carbon tetrafluoride, carbon tetrachloride, carbon tetrabromide, chlorine, fluorine, bromine, and combinations thereof.

5. The process of claim 1 wherein the gas is a non-functionalizing gas that prevents combustion of the nanoparticles within the chamber.

6. The process of claim 5 wherein the gas is selected from the group consisting of carbon dioxide, nitrogen, and combinations thereof.

7. The process of claim 1 wherein a D.C. voltage on the order of 20 KV is applied to the electrically conductive surfaces.

8. The process of claim 7 wherein opposite poles of the D.C. voltage are connected to respective ones of the electrically conductive surfaces.

9. The process of claim 7 wherein the electrically conductive surfaces are connected together, and the D.C. voltage is applied between the conductive surfaces and an electrically conductive screen disposed between the electrically conductive surfaces.

10. The process of claim 7 wherein nanoparticles attracted to the second electrically conductive surface are removed on a continuous basis.

11. The process of claim 1 wherein the nanoparticles are placed in a pile on the first conductive surface.

12. The process of claim 11 including the step of adding additional nanoparticles to the pile on top of nanoparticles remaining on the first conductive surface after the high voltage charge has been applied.

13. The process of claim 1 wherein the nanoparticles are graphene nanoparticles prepared by combusting magnesium and carbon dioxide together in a highly exothermic reaction.

14. The process of claim 13 wherein graphene nanoparticles produced by combustion are separated, purified, ground, and screened to provide particles ranging in size from about 120 mesh to about 400 mesh.

15. The process of claim 1 wherein the particles placed on the first conductive surface are graphene nanoparticles having a cross sectional dimension on the order of 10 microns, and the particles collected on the second conductive surface have a cross sectional dimension on the order of 1 micron.

16. Apparatus for functionalizing and/or separating nanoparticles, comprising: a closed chamber, a first electrode having a surface on which the nanoparticles to be functionalized and/or separated are placed, a second electrode having a surface spaced from the surface of the first electrode, means gas at ambient pressure, and a source for applying a high voltage electrical charge to the electrodes to attract a portion of the nanoparticles from the first electrode to the surface of the second electrode.

17. The apparatus of claim 16 wherein the second electrode is spaced vertically above the first electrode.

18. The apparatus of claim 16 wherein the high voltage electrical charge is applied between the electrodes.

19. The apparatus of claim 16 including an electrically conductive screen disposed between the electrodes, with the high voltage electrical charge being applied between the screen and the electrodes.

20. The apparatus of claim 16 wherein the electrodes are generally rectangular flat plates.

21. The apparatus of claim 16 wherein the second electrode is of lesser lateral extent than the first electrode and aligned with a central area of the first electrode.

22. The apparatus of claim 16 wherein the electrodes are concave plates which curve inwardly toward each other.

23. The apparatus of claim 16 wherein the electrodes are convex plates which curve outwardly away from each other.

24. The apparatus of claim 16 wherein the electrodes are circular plates which rotate about horizontally spaced vertical axes, with the second electrode spaced above the first electrode and the nanoparticles being placed on and attracted to overlapping outer portions of the two electrodes.

25. The apparatus of claim 16 wherein the first electrode is a flat plate, and the second electrode is a cylindrical drum that rotates about a horizontally extending axis above the flat plate.

26. The apparatus of claim 16 wherein the second electrode is a flat plate mounted for movement back and forth above the first electrode, and a collection trough is mounted in a stationary position near one end of the first electrode, with a scraper adjacent to the trough for scraping nanoparticles into the trough from the lower side of the second electrode plate.

27. The apparatus of claim 16 wherein the gas is a functionalizing gas, and the nanoparticles attracted to the surface of the second electrode take on characteristics of the functionalizing gas.

28. The process of claim 27 wherein the functionalizing gas is selected from the group consisting of oxygen, nitrogen, water vapor, hydrogen peroxide, carbon dioxide, ammonia, ozone, carbon monoxide, silane, dimethysilane, trimethylsilane, tetraetoxysilane, hexamethyldisioxane, chloro-silanes, fluoro-silanes, ethylene diamine, maleic anhydride, arylamine, acetylene, methane, ethane , propane, butane, ethylene oxide, hydrogen, air, sulfur dioxide, hydrogen, sulfonyl precursors, argon, helium, alcohols, methanol, ethanol, propanol, carbon tetrafluoride, carbon tetrachloride, carbon tetrabromide, chlorine, fluorine, bromine, and combinations thereof.

29. The process of claim 16 wherein the gas is a non-functionalizing gas that prevents combustion of the nanoparticles within the chamber.
